(19) United States
(12) Patent Application Publication
(10) Pub. No.: US 2017/0169454 A1
(43) Pub. Date: Jun. 15, 2017

(54) IDENTIFYING BUSINESS ONLINE SOCIAL PRESENCE WITH NAME AND ADDRESS USING SPATIAL FILTERS

(71) Applicant: Pitney Bowes Inc., Danbury, CT (US)

(72) Inventors: Qiuju Gu, Trumbull, CT (US); Hongping Liang, Bethany, CT (US); Michael P. Swenson, Brookfield, CT (US); Yuling Wu, Scarsdale, NY (US); Jun Zhang, Shelton, CT (US)

(73) Assignee: Pitney Bowes Inc., Danbury, CT (US)

(21) Appl. No.: 14/965,946

(22) Filed: Dec. 11, 2015

(51) Int. Cl. G06Q 30/02; G06Q 50/00; H04L 29/08

(52) U.S. Cl. CPC G06Q 30/0205; H04L 67/18; G06Q 50/01

(57) ABSTRACT

Methods and systems for better identifying a business's online social presence using name and address as provided. Geocoding technology is used to enhance business location information with geographic coordinates. A scanning engine is provided that can search a wide range of social media spaces, including, for example and without limitation, FaceBook, Twitter, Yelp, LinkedIn, YouTube, Flickr, Blog, etc. to identify the social presence of a business. The search is performed using the business's name and a defined spatial boundary based on the geographic coordinates and inferred contextual information, thereby reducing the ambiguity caused by information incompleteness and variation in social profiles. Utilizing the spatial filters results in an improved match rate and match accuracy.

### FIELD OF THE INVENTION

The invention disclosed herein relates generally to online social networking, and more particularly to a method and system for identifying a business's online social presence by name and address using spatial fillers.

### BACKGROUND OF THE INVENTION

With the rapid adoption of portable processing devices, e.g., smartphones, tablets, and the like, more and more businesses are using social media as an important channel to engage and interact with consumers (B2C) and other businesses (B2B). Accordingly, managing a business presence on social media is becoming strategically more important for businesses of all kinds in order to listen, engage and reach customers (either consumers or other businesses), and to extract additional business insights from social data. However, business information in social media profiles can be incomplete, full of variation and noise, and inconsistent depending on how they are generated and used. This makes it a challenging task to identify the social presence of a business using its known name and address only. Current solutions require either an additional attribute (e.g., a URL), which may not always be available, to resolve social presence identification issues, or deliver a relatively low match accuracy due to the information variation, incompleteness and contextual constraints in social profiles.

### SUMMARY OF THE INVENTION

The present invention alleviates the problems described above and provides a method and system which can better identify a business's online social presence using a name and address. Gecoding technology is used to enhance business location information with geographic coordinates. A scanning engine is provided that can search a wide range of social media spaces, including, for example and without limitation, FaceBook, Twitter, Yelp, LinkedIn, YouTube, Flickr, Blog, etc. to identify the social presence of a business. The search is performed using the business's name and a defined spatial boundary based on the geographic coordinates, thereby reducing the ambiguity caused by information incompleteness and variation in social profiles. Utilizing the spatial filters results in an improved match rate and match accuracy.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates a block diagram of a system according to an embodiment of the present invention, and

FIG. 2 illustrates in floe diagram form the processing performed according to an embodiment of the present invention.

### DETAILED DESCRIPTION OF THE PRESENT INVENTION

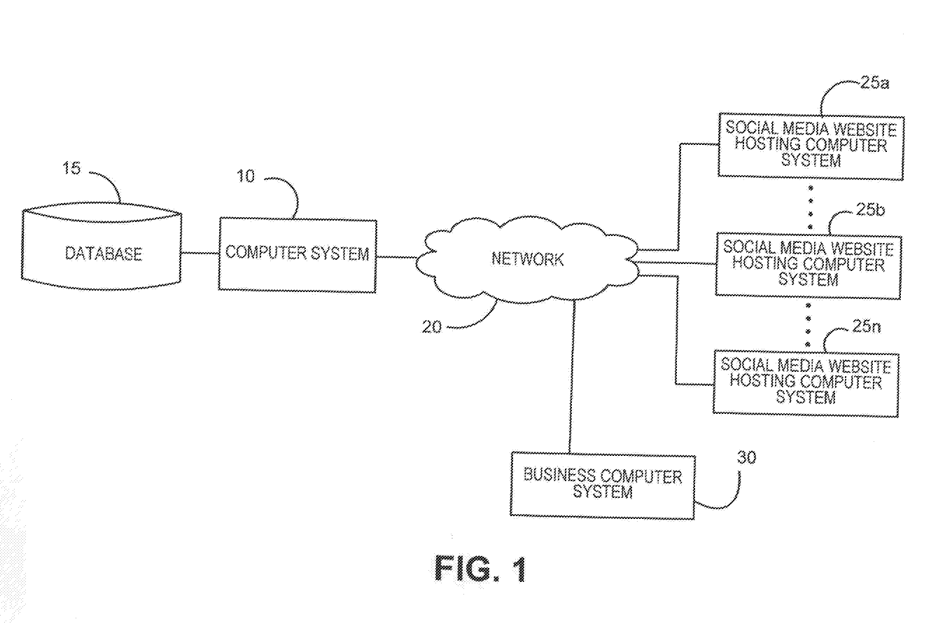

In describing the present invention, reference is made to the drawings, wherein there is seen in FIG. 1 a block diagram of a system according to an embodiment of the present invention. As illustrated in FIG. 1, a computer system 10 is in electronic communication with a network 20, which may be, for example, the Internet, one or more private computer networks, or any combination thereof. The computer system 10 is also in electronic communication with a database 15. Database 15 stores information including, for example and without limitation, social media information obtained as described below. One or more social media website hosting computer systems (25a, 25b . . . 25n), are coupled to the network 20. Each hosting computer system can host one or more social media websites. Additionally, a business' computer system 30, which may be, for example, a personal computer or the like, is coupled to the network 30 and allows business to access and use the present invention as well as social media websites hosted by the computer systems 25a-25n. It should be understood that the number of social media website hosting computer systems 25 and business computer systems 30 are not limited in number, and any number can be connected to the network 20.

The present invention includes various software engines/processes that can be executed by the computer system 10. It is designed to support a wide range of social media data sources, including, for example and without limitation. FaceBook, Twitter, Yelp, LinkedIn, YouTube, Flickr, Blog, etc. A social media scanning engine, which is preferably a standalone Java application, is configured and executed by computer system 10 to crawl through the social media data sources to collect social media data as described below. In general, there are instances when a business is attempting to determine whether or not its business customers (B2B) have a presence on social media sites and exactly how they are identified on those social media sites, also referred to as a social media handle. However, business information in social media profiles can be incomplete, full of variation and noise, and inconsistent depending on how they are generated and used. This makes it a challenging task to identify the social presence of a business using its known name and address only.

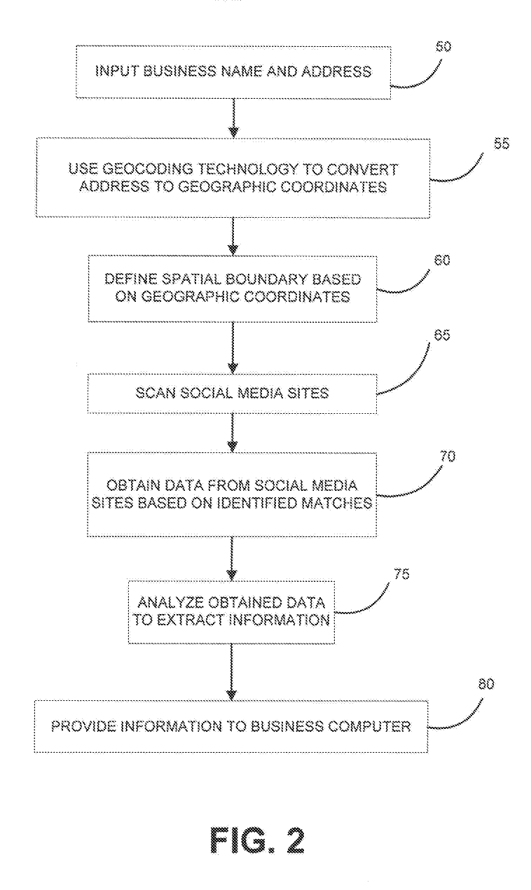

Referring now to FIG. 2, there is illustrated in flow diagram form the processing performed by the computer system 10 according to an embodiment of the present invention to better identify a business's online social presence using geocoding technology to enhance business location information with geographic coordinates. In step 50, a user will provide the computer system 10 with a name and address (or list of names and addresses) of its business customers. This can be provided, for example, by the user using a business computer system 30 to provide information to the computer system 10. In step 55, the computer system 10 uses geocoding technology to convert the provided address(es) to geographic coordinates. Such geocoding technology can be, for example, cloud-based geocoding APIs (such as a geocoding web service provided by Pitney Bowes, Google, Mapquest, or Microsoft) or a geocoding engine operating on the computer system 10. The address is passed to the web service or engine and the geographic coordinates (latitude and longitude) are returned. In step 60, the computer system 10 determines a spatial boundary, such as, for example, a circle having the determined geographic coordinates as the center with some determined radius, or a bounding box that contains the determined geographic coordinates. The radius could be, for example, a predetermined fixed value, e.g., one mile, two miles, etc., for every geographic coordinate. Alternatively, the radius could be individually determined for each geographic coordinate based on one or more factors associated with each geographic coordinate. Such factors could include, for example, demographic information associated with the area in which the geographic coordinate is located. Such demographic information could include, for example, the business density, the population density, rural or urban area, etc. Thus, the radius could be increased or decreased by the computer system 10 based on such information. It should be understood that the present invention is not limited to using a circular spatial boundary, and instead any shape of boundary can be used. In step 65, the scanning engine executed by the computer system 10 provides the various social media sites' APIs with the business name and determined spatial boundary to scan each site for potential matches.

Each social media site will be scanned to identify those businesses that match the input criteria, i.e., business name and physically located within the defined spatial boundary. In step 70, the scanning engine obtains data from the social media sites based on the matches identified, e.g. a list of those businesses that match the input criteria along with their social media handles. In step 75, an analytics engine executed on computer system 10 analyzes the data obtained in step 70 to extract information relevant to the original request, e,g., whether the business customer has a presence on a social media site and an identification of their social media handle. This is performed by comparing the returned matches with the input data (business name/address) to determine the best likely match. If more than one match was returned from a social media site, the analytics engine can perform one or more cross-checks with other data to provide the best match. Such other data could include, for example, a telephone number. The collected data and determined matches can be stored in the database 15. Preferably, the data is time stamped for each identification attempt and the result. Additional processes can be performed to review the data collected and provide additional insights into the business, such as those described in application Ser. No. 13/368,515, the contents of which is herein incorporated by reference.

In step 80, a report is generated that includes the information relevant to the original request, i.e., which business customers have a presence which social media sites, and what their social media handle is for those sites, and returned from the computer system 10 the business computer system 30. Because the computer system 10 used geographic coordinates as a filter for searching through the social media sites, any ambiguity caused by information incompleteness and variation in social profiles is significantly reduced thereby resulting in an improved match rate and match accuracy.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a business to determine business customer social media activity, the method comprising:
receiving, by a processing device, business name and address information related to at least one business customer of the business;
converting, by the processing device, the address information to geographic coordinates;
defining, by the processing device, a spatial boundary based on the geographic coordinates;
scanning, by the processing device, at least one social media site to identify potential matches with the business name that are physically located within the defined spatial boundary;
receiving, by the processing device, a list of businesses that are potential matches with the business name that are physically located within the defined spatial boundary, the list including a social media handle for each business included on the list;
analyzing, by the processing device, the received list to determine a most likely match with the business name and address information; and
generating, by the processing device, a report indicating the most likely match and the social media handle for the most likely match for the at least one social media site.

2. The method of claim 1, wherein the spatial boundary is a circle with the geographic coordinates as its center.

3. The method of claim 2, wherein the circle has a predetermined radius,

4. The method of claim 2, wherein the circle has a radius that is determined based on one or more factors associated with the geographic coordinates.

5. The method of claim 4, wherein the one or more factors include demographic information associated with an area in which the geographic coordinates is located.

6. The method of claim 1, wherein the spatial boundary is a bounding box.

7. The method of claim 1, wherein analyzing the received list further comprises:
cross-checking the received list with other data to determine a most likely match.

8. The method of claim 1, wherein the at least one social media site comprises a plurality of social media sites and analyzing the collected data further comprises:
determining a most likely match for each of the plurality of social media sites.

9. A system for determining social media activity of a business's customer, the system comprising:
a processing device coupled to a network, the processing device being programmed receive business name and address information related to at least one business customer of the business; convert the address information to geographic coordinates; define a spatial boundary based on the geographic coordinates; scan at least one social media site to identify potential matches with the business name that are physically located within the defined spatial boundary; receive a list of businesses that are potential matches with the business name that are physically located within the defined spatial boundary, the list including a social media handle for each business included on the list; analyze the received list to determine a most likely match with the business name and address information: and generate a report indicating the most likely match and the social media handle for the most likely match for the at least one social media site.

10. The system of claim 9, wherein the spatial boundary is a circle with the geographic coordinates as its center.

11. The system of claim 10, wherein the circle has a predetermined radius.

12. The system of claim 10, wherein the circle has a radius that is determined based on one or more factors associated with the geographic coordinates.

13. The system of claim 12, wherein the one or more factors include demographic information associated with an area in which the geographic coordinates is located.

14. The system of claim 9, wherein the spatial boundary is a bounding box.

15. The system of claim 9, wherein the processing device is further programmed to cross-check the received list with other data to determine a most likely match.

16. The system of claim 9, wherein the at least one social media site comprises a plurality of social media sites, and the processing device is further programmed to determine a most likely match for each of the plurality of social media sites.
